(19) United States
(12) Patent Application Publication
(10) Pub. No.: US 2007/0149157 A1
(43) Pub. Date: Jun. 28, 2007

(54) Method and apparatus for transmitting signals using multiple antennas in a wireless communication system

(75) Inventors: Sung-Soo Hwang, Suwon-si (KR); Young-Hoon Kwon, Seongnam-si (KR); Won-Kyun Suk, Dobong-gu (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONIC CO., LTD., Suwon-si (KR)

(21) Appl. No.: 11/529,008

(22) Filed: Sep. 28, 2006

(30) Foreign Application Priority Data
Sep. 28, 2005 (KR) 10-2005-0090606

(51) Int. Cl. H04B 1/06

(52) U.S. Cl. 455/276.1; 455/139

(57) ABSTRACT

A method and apparatus for transmitting a signal through multiple antennas in a wireless communication system. Channels from a Mobile Station (MS) are estimated. Channel variation and an electromagnetic wave of the estimated channels are measured and a polarization phase of the measured electromagnetic wave is measured. The channel variation is compared with a threshold and a signal is sent corresponding to a comparison result.

### PRIORITY

This application claims priority under 35 U.S.C. §119 to an application filed in the Korean Intellectual Property Office on Sep. 28, 2005 and assigned Serial No. 2005-90606, the contents of which are incorporated herein by reference.

### BACKGROUND OF THE INVENTION

1. Field of the Invention

The present invention relates generally to signal transmission in a wireless communication system, and in particular, to a method and apparatus for transmitting signals through multiple antennas according to a channel change in a wireless communication system.

2. Description of the Related Art

Duplexing schemes used in a wireless communication system include Frequency Division Duplexing (FDD) and Time Division Duplexing (TDD). In FDD, uplink and downlink transmissions are duplexed in frequency, while in TDD, they are duplexed in time.

Since different frequencies are used for the uplink and the downlink in FDD, a transmitting side (e.g. a Base Station (BS)) and a receiving side (e.g. a Mobile Station (MS)) each have separate transmit (Tx) and receive (Rx) antennas, for FDD operation. In other words, the BS and the MS each have a transmitter with a Tx antenna and a receiver with an Rx antenna.

Compared to FDD, TDD is a duplexing scheme in which the uplink and the downlink are duplexed in time. A TDD wireless communication system separates an uplink time interval from a downlink time interval because the uplink and the downlink share the same frequency. Thus, an uplink signal is sent only in the uplink time interval, and a downlink signal is sent only in the downlink time interval.

Despite the increase of scheduling complexity in uplink and downlink signal transmission/reception relative to FDD, TDD increases frequency use efficiency.

To improve the performance of a communication link using a plurality of antennas, the wireless communication system adopts beamforming. There are Rx beamforming and Tx beamforming. Rx beamforming is a beamforming scheme in which the receiver receives a signal from a reception direction when Rx antennas are correlated mutually. Rx beamforming is feasible for the BS to receive uplink signals. Tx beamforming increases transmission reliability when signals are sent through a plurality of Tx antennas.

In a Maximal Ratio Combining (MRC)-based Tx beamforming scheme, the receiver estimates a channel that each antenna experiences, compensates the channel estimates, and adds the compensation values. MRC-based Tx beamforming improves the Signal-to-Noise Ratio (SNR) of the receiver. The transmitter may carry out Tx beamforming using channel information estimated by the receiver.

When a TDD wireless communication system uses Tx beamforming, there is almost no channel change during the interval between the uplink and the downlink if the MS moves slowly, because the uplink and the downlink use the same carrier frequency. Therefore, Tx beamforming is performed using channel information estimated by the receiver as it is. Also, the TDD wireless communication system can cancel interference by use of a plurality of antennas, and thus carry out beamforming for a plurality of MSs simultaneously. This technique is called Spatial Division Multiple Access (SDMA).

When the channel changes slowly, Tx beamforming is carried out based on the assumption that the downlink channel is in the same channel condition as estimated for the uplink channel. If uplink channels from a plurality of MSs are estimated, SDMA can be performed through Tx beamforming for the MSs based on the uplink channel estimates in a non-interfering manner. With reference to FIG. 1, a Tx beamforming operation based on channel estimation will be described below.

FIG. 1 shows a receiver and a transmitter for beamforming in a typical wireless communication system. A receiver 110 includes Rx antennas 101 and 111 for estimating instantaneous uplink channels H₁ and H₂, multipliers 103 and 113 for multiplying the estimated instantaneous channels H₁ and H₂ by their conjugates H₁* and H₂*, and an adder 120 for adding the products. After estimating the instantaneous channels H₁ and H₂ through the Rx antennas 101 and 111, the receiver 100 performs an MRC operation through the multipliers 103 and 113 and the adder 120.

A transmitter 150 includes an adder 170, multipliers 153 and 163, and Tx antennas 151 and 161, for Tx beamforming based on estimates of the uplink instantaneous channels H₁ and H₂ received from the receiver 100. The multipliers 153 and 163 use the conjugates H₁* and H₂* in multiplications, as done in the multipliers 103 and 113 of the receiver 100.

When an MS moves slowly, there is little channel change during the time interval between the uplink and downlink. This means that the uplink instantaneous channel estimate of the receiver is rarely changed. Therefore, Tx beamforming based on the channel estimate is possible in the TDD wireless communication system using Tx beamforming and SDMA. However, if the MS moves fast, there is no guarantee that the downlink channel is equal to the uplink channel estimate. Hence, there are limits on Tx beamforming using the instantaneous channels estimated by the receiver. Also, Tx beamforming under an environment where the MS moves fast, and thus the channel also changes fast, may suffer from degradation of transmission performance, compared to omni-direction transmission. As to SDMA, transmission beams are decided so interference among MSs is eliminated. Yet, due to the channel discrepancy between the downlink and the uplink, the interference is not canceled, resulting in performance degradation.

### SUMMARY OF THE INVENTION

An object of the present invention is to substantially solve at least the above problems and/or disadvantages and to provide at least the advantages below. Accordingly, the present invention provides a method and apparatus for transmitting signals through multiple antennas according to a channel change in a wireless communication system.

The present invention provides a method and apparatus for transmitting a signal by changing a signal transmission scheme according to a velocity of an MS in a wireless communication system.

According to one aspect of the present invention, in a method of transmitting a signal through multiple antennas in a wireless communication system, channels from an MS are estimated. Channel variation and an electromagnetic wave of the estimated channels are measured and a polarization phase of the measured electromagnetic wave is measured. The channel variation is compared with a threshold and a signal is sent corresponding to a comparison result.

According to another aspect of the present invention, in an apparatus for transmitting a signal through multiple antennas in a wireless communication system, a receiver estimates channels from an MS, measures channel variation and an electromagnetic wave of the estimated channels, and measures a polarization phase of the measured electromagnetic wave. A transmitter compares the channel variation with a threshold and transmits a signal corresponding to a comparison result.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the structures of a receiver and a transmitter for beamforming in a typical wireless communication system;

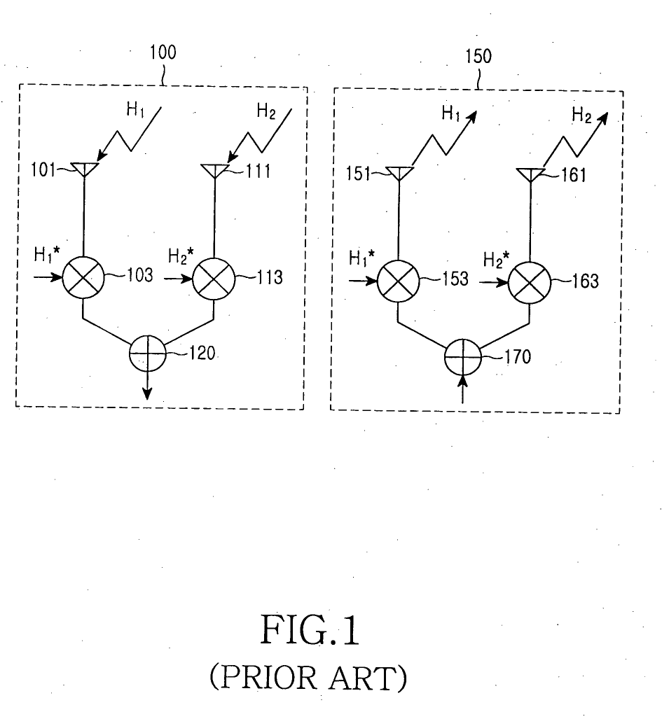

FIG. 2 illustrates electric propagation in a wireless communication system according to the present invention;

FIG. 3 is a block diagram of a transmitter and a receiver in a BS that sends a signal based on polarization in a wireless communication system according to the present invention;

FIG. 4 is a block diagram of a BS receiver in a wireless communication system according to the present invention;

FIG. 5 is a block diagram of a BS transmitter in a wireless communication system according to the present invention; and

FIG. 6 is a flowchart illustrating a BS operation in a wireless communication system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides a technique for sending signals through multiple antennas according to a channel change in a wireless communication system. In particular, the present invention provides a method and apparatus for sending a signal by matching the polarization of electromagnetic waves when a channel changes fast, and by beamforming when the channel changes slowly. The present invention provides a transmitting side (e.g. a Base Station (BS)) communicating with a receiving side (e.g. a Mobile Station (MS)). The transmitting side has a receiver and a transmitter each having one or more antennas. The receiver estimates an uplink channel, and measures the variation and polarization phase of the uplink channel. Then the transmitter sends a signal corresponding to the estimate and measurements to the MS. The signal transmission is at least one of signal transmission after polarization phase matching and beamforming.

While the present invention is described in the context of a Time Division Duplexing (TDD) wireless communication system, it is to be clearly appreciated that the present invention is applicable to any wireless communication system with transmit (Tx) and receive (Rx) antennas. For better understanding of the present invention, it will be described below that electromagnetic waves, especially an electric field and its polarization phase are measured and the polarization of the electric field is matched. Yet, the present invention is also applicable when, instead of an electric field, a magnetic field is measured and the polarization of the magnetic field is matched. Therefore, the present invention is also applicable when the x-axis, y-axis, and z-axis polarization phases of the electric and magnetic fields are measured, the polarization phase measurements are compensated, and then polarization matching is performed, prior to transmission.

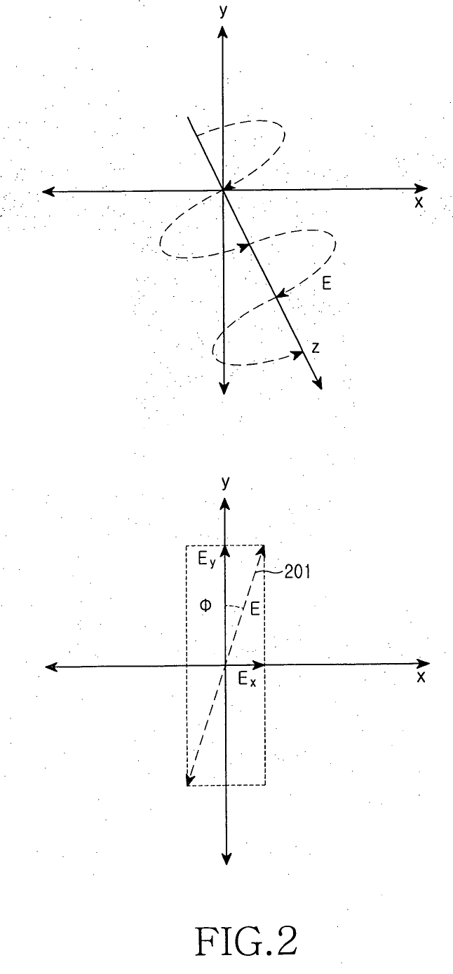

FIG. 2 shows propagation of electric waves in a wireless communication system according to the present invention. The phase of electric waves is propagated across space according to the polarization of an antenna. Assuming that the electric field E of the electric waves is propagated in a z-axis direction, the x-y plane electric field E denoted by reference numeral 201 at a position has an x-axis electric field Eₓ, a y-axis electric field E_{y}, and a particular polarization phase φ. The electric field E 201 is determined according to the polarization of the antenna, the spatial position of the antenna, and reflection and diffraction in surroundings.

If an Rx antenna is polarized with a particular phase, it has a maximum reception power when receiving waves polarized with the polarization phase. In other words, the Rx antenna has a maximum reception power when it receives waves polarized with a phase corresponding to its own polarization phase. Therefore, the polarization can be utilized to increase efficiency by distinguishing an intended wave or adjusting the polarization angle of a Tx/Rx antenna in the wireless communication system using antennas. Although a random polarization phase is propagated instantaneously due to a phase delay caused by the polarization phase φ of the transmit antenna and reflection and diffraction from a surrounding object, the average of reception power measured for a period reveals that electric waves are propagated, polarized with a constant phase irrespective of frequency or the velocity of a receiver.

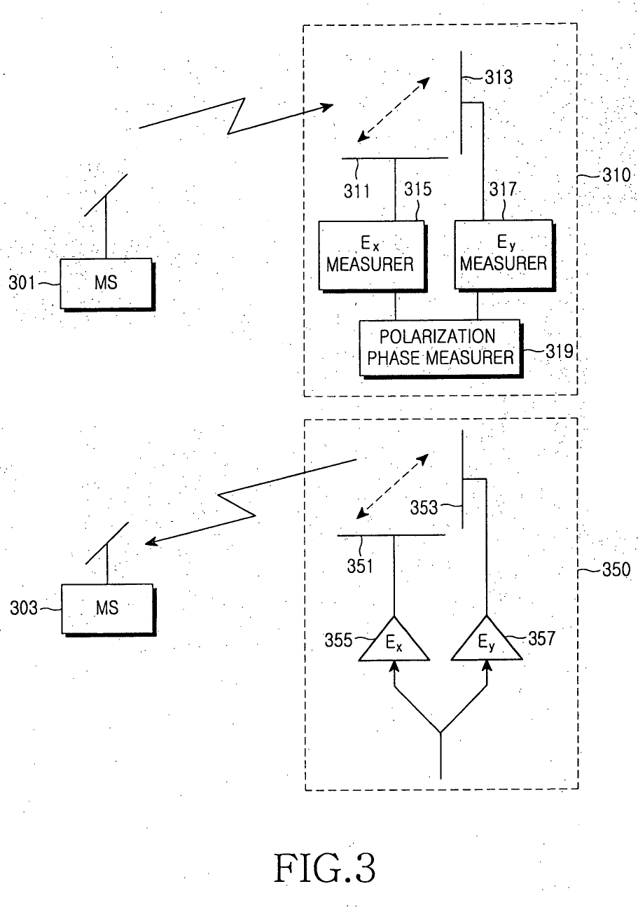

FIG. 3 shows signal transmission and reception based on the polarization property of electric waves in a wireless communication system according to the present invention. A receiver 310 of a BS includes two perpendicular, i.e. vertical and horizontal polarization Rx antennas 311 and 313, electric field measurers for measuring electric fields Eₓ and E_{y} received at the Rx polarization antennas 311 and 313, i.e. an Eₓ measurer 315 and an E_{y} measurer 317, and a polarization phase measurer 319.

The two Rx polarization antennas 311 and 313 receive uplink electric fields from an MS 301. Specifically, the x-axis polarization antenna 311 receives the x-axis electric field Eₓ and the y-axis polarization antenna 313 receives the y-axis electric field E_{y}. The Eₓ measurer 315 and the E_{y} measurer 317 measure the x-axis electric field Eₓ and the y-axis electric field E_{y}, respectively. The polarization phase measurer 319 measures the polarization phase φ by Equation (1)

$$ϕ = {tan}^{- 1} ( \frac{{E}_{y}}{{E}_{x}} ) \qquad ( 1 )$$

After the polarization phase measuring, the BS compensates the polarization phase φ (i.e. polarization matching) and receives a signal from the MS 301 with the compensated polarization phase φ. Therefore, the reception Signal-to-Noise Ratio (SNR) is increased. For example, the positions and directions of the polarization antennas 311 and 313 for compensation of the measured polarization phase φ. As the compensated polarization phases of the polarization antennas 311 and 313 are matched to that of a signal sent by the MS 301, the receiver 310 has a maximum reception power.

In the BS, a transmitter 350 includes two perpendicular, i.e. vertical and horizontal, Tx polarization antennas 351 and 353, and electric field polarization matchers 355 and 357 (i.e. an Eₓ polarization matcher 355 and an E_{y} polarization matcher 357). For downlink transmission to an MS 303, the polarization matchers 355 and 357 match electric fields Eₓ and E_{y} to the polarization phase φ measured by the receiver 310. The Tx polarization antennas 351 and 353 send the polarization phase-matched electric fields Eₓ and E_{y} to the MS 303, thereby maximizing the reception power of the MS 303. That is, as the transmitter 350 sends a signal polarization-matched to the Rx antenna of the MS 303, the MS 303 has the maximum reception power.

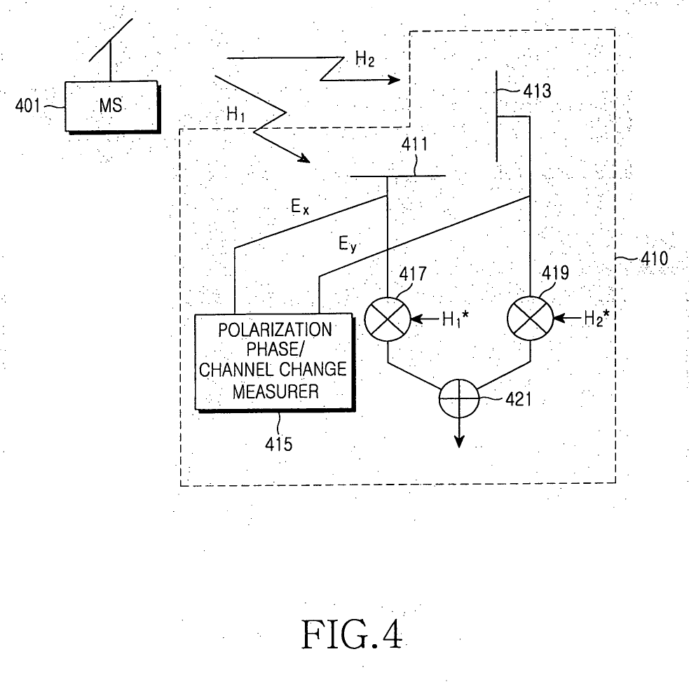

FIG. 4 shows a BS receiver in a wireless communication system according to the present invention. A BS receiver 410 includes two perpendicular, i.e. vertical and horizontal, Rx polarization antennas 411 and 413, a polarization phase/channel change measurer 415, multipliers 417 and 419, and an adder 421.

The Rx polarization antennas 411 and 413 estimate uplink instantaneous channels H₁ and H₂ having polarization properties received from an MS 401. The multipliers 417 and 419 multiply the estimated instantaneous channels H₁ and H₂ by their conjugates H₁* and H₂*. The adder 421 adds the products received from the multipliers 417 and 419. That is, the receiver 410 estimates the estimated instantaneous channels H₁ and H₂ at the Rx polarization antennas 411 and 413, multiplies the estimated instantaneous channels H₁ and H₂ by their conjugates H₁* and H₂* at the multipliers 417 and 419, and adds the products at the adder 421, thus performing a Maximal Ratio Combining (MRC).

The polarization phase/channel change measurer 415 measures the electromagnetic waves of the instantaneous channels H₁ and H₂ received from the Rx polarization antennas 411 and 413, especially their electric fields, Eₓ and E_{y}. Then the polarization phase/channel change measurer 415 measures the polarization phase φ of the electric fields by Equation (1) and measures a channel variation S using the instantaneous channels H₁ and H₂. Specifically, the polarization phase/channel change measurer 415 measures the channel variation S using an instantaneous channel H(n) estimated from an nth frame and an instantaneous channel H(n+1) estimated from the next (n+1)^{th} frame by Equation (2)

$$S = \frac{1}{N} {\sum }_{n - 1}^{N} {\vert H ( n + 1 ) - H ( n ) \vert}^{2} \qquad ( 2 )$$

In this way, the receiver 410 performs the above MRC operation by estimating the instantaneous channels H₁ and H₂ in every frame and measures the channel variation S and electric fields Eₓ and E_{y} of the instantaneous channels H₁ and H₂, and the polarization phase φ of the electric fields Eₓ and E_{y}.

The BS then sends a signal to the MS 401 through a transmitter in accordance with the instantaneous channels H₁ and H₂, the channel variation S, the electric fields Eₓ and E_{y}, and the polarization phase φ. That is, the BS transmitter sends a signal to the MS 401 corresponding to the instantaneous channels H₁ and H₂, the channel variation S, the electric fields Eₓ and E_{y}, and the polarization phase φ.

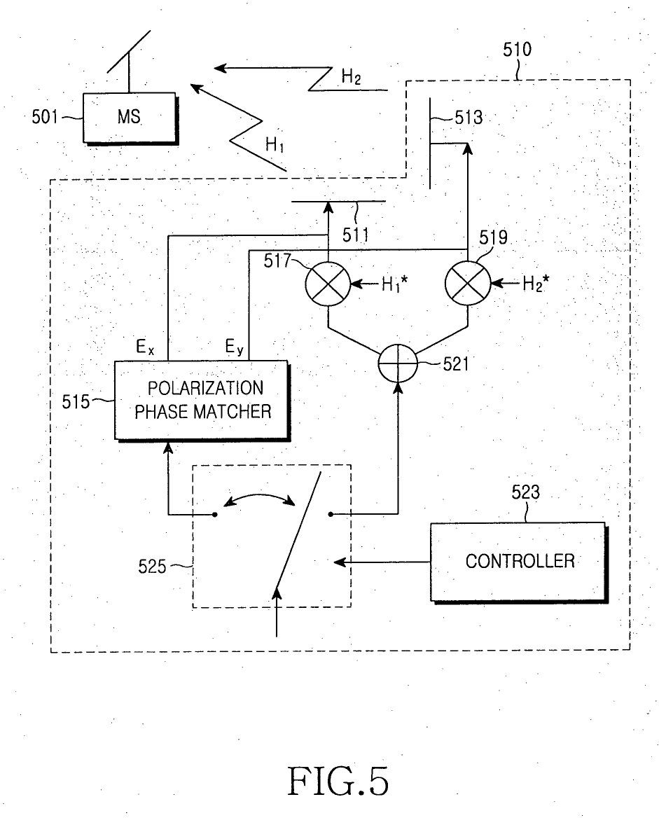

FIG. 5 shows a BS transmitter in a wireless communication system according to the present invention. A BS transmitter 510 includes two perpendicular, i.e. vertical and horizontal, Tx polarization antennas 511 and 513, a polarization phase matcher 515, multipliers 517 and 519, an adder 521, a controller 523, and a switch 525.

The controller 523 compares the channel variation S received from the receiver 410 shown in FIG. 4 with a threshold preset by a user for signal transmission to an MS 501 in accordance with a radio channel environment, and controls switching of the switch 525 according to the comparison result. If the channel variation S is greater than the threshold, the controller 523 switches the switch 525 to the polarization phase matcher 515 to perform polarization matching and thus compensate a polarization phase with no relation to the channel variation, considering that the channel changes fast.

On the other hand, if the channel variation S is less than or equal to the threshold, the controller 523 considers that the channel changes slowly and thus determines that the downlink and uplink channels are identical. Therefore, the controller 523 switches the switch 525 to the adder 521 to perform beamforming using a channel estimation-based MRC.

In the former case, as the switch 525 is connected to the polarization phase matcher 515, the polarization phase matcher 515 matches the polarization phase of the electric fields Eₓ and E_{y} of a downlink signal to be sent to the MS 501 to the received polarization phase φ, and sends the downlink signal to the MS 501 through the Tx polarization antennas 511 and 513. Thus, the MS 501 has a maximum reception power. In this way, for a fast channel change, the transmitter 510 sends a signal through polarization matching with no relation to the channel change.

In the latter case, as the switch 525 is connected to the adder 521, the adder 521 and the multipliers 517 and 519 perform beamforming using the afore-described MRC in correspondence with the instantaneous channels H₁ and H₂ estimated by the receiver 410 and then send the downlink signal to the MS 501 through the Tx polarization antennas 511 and 513. In this way, for a slow channel change, the transmitter 510 performs Spatial Division Multiple Access (SDMA) through MRC-based beamforming in correspondence with the channel estimation, thereby canceling signal interference.

Meanwhile, the MS 501 receives signals from the transmitter 510 through a single antenna irrespective of whether the transmitter 510 uses MRC-based beamforming or polarization matching for signal transmission. Therefore, even if the transmitter changes its transmission scheme, there is no need for notifying the MS of the transmission scheme. As a consequence, there is no need for sending an additional message and modifying the structure of the MS for receiving signals in the changed transmission scheme.

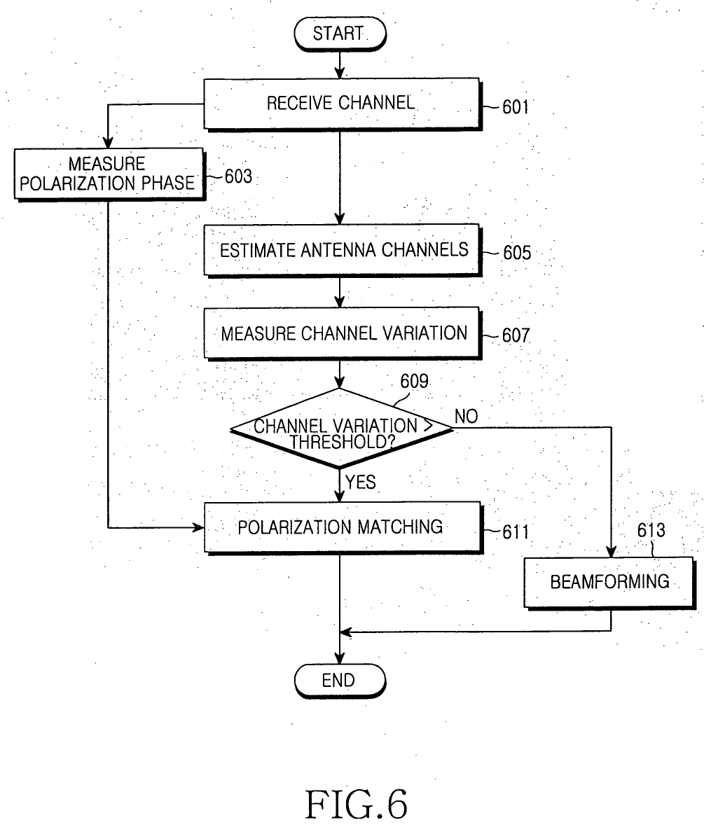

FIG. 6 shows a BS operation for sending signals through one or more antennas in the wireless communication system according to the present invention. Upon receipt of an uplink channel from an MS through the two perpendicular (vertical and horizontal) Rx polarization antennas in step 601, the BS receiver proceeds to steps 603 and 605. In step 603, the BS receiver measures the x-axis and y-axis electric fields Eₓ and E_{y} of the received channel and then their polarization phase φ. The BS receiver estimates the instantaneous channels of the Rx polarization antennas from the received uplink channel in step 605 and measures a channel change using the estimated instantaneous channels in step 607. In step 609, the BS transmitter compares the channel variation with a threshold preset for signal transmission between the BS and the MS according to a radio channel environment.

If the channel variation is greater than the threshold, the BS transmitter matches the polarization phase of electric fields Eₓ and E_{y} of a downlink signal to the measured polarization phase φ and sends the downlink signal to the MS through the Tx polarization antennas, considering that the channel changes fast in step 611.

On the contrary, if the channel variation is less than or equal to the threshold, the BS transmitter performs beamforming by an MRC based on the estimated channels and sends the beamformed downlink signal to the MS through the Tx polarization antennas, considering that the channel changes slowly in step 613.

As described above, the present invention sends a signal corresponding to a channel change in a wireless communication system, thereby preventing performance degradation of beamforming and realizing SDMA through interference cancellation. Also, signals are sent by selecting a signal transmission scheme between polarization matching and beamforming adaptively according to a velocity of an MS. Furthermore, since signals are sent without the need for modifying a system configuration and using an additional message, system efficiency is increased.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of transmitting a signal through multiple antennas in a wireless communication system, the method comprising the steps of:
estimating channels from a Mobile Station (MS);
measuring channel variation and an electromagnetic wave of the estimated channels, and measuring a polarization phase of the measured electromagnetic waves;
comparing the channel variation with a threshold; and
transmitting a signal corresponding to a comparison result.

2. The method of claim 1, wherein the transmitting step comprises:
transmitting the signal by beamforming based on an estimated channel when channel variation of the signal is less than or equal to the threshold; and
transmitting the signal by polarization matching based on a measured polarization phase when channel variation of the signal is greater than the threshold.

3. The method of claim 2, wherein the transmitting the signal by polarization matching comprises matching a polarization phase of an electromagnetic wave of a transmission signal to a polarization phase of a measured electromagnetic wave.

4. The method of 2, wherein the transmitting the signal by beamforming comprises performing a Maximal Ratio Combining (MRC) on the estimated channels.

5. The method of claim 1, wherein the estimating channels comprises estimating the channels in every frame of a signal received from the MS.

6. An apparatus for transmitting a signal through multiple antennas in a wireless communication system, the apparatus comprising:
a receiver for estimating channels from a Mobile Station (MS), measuring channel variation and an electromagnetic wave of the estimated channels, and measuring a polarization phase of the measured electromagnetic wave; and
a transmitter for comparing a channel variation with a threshold and transmitting a signal corresponding to a comparison result.

7. The apparatus of claim 6, wherein the transmitter transmits the signal by beamforming based on an estimated channel when channel variation of the signal is less than or equal to the threshold, and transmits the signal by polarization matching based on a measured polarization phase of the signal when channel variation of the signal is greater than the threshold.

8. The apparatus of claim 7, wherein the transmitter matches a polarization phase of an electromagnetic wave of a transmission signal to a polarization phase of a measured electromagnetic wave.

9. The apparatus of 7, wherein the transmitter performs a Maximal Ratio Combining (MRC) on the estimated channels.

10. The apparatus of claim 6, wherein the receiver estimates the channels in every frame of a signal received from the MS.

11. The apparatus of claim 6, wherein the receiver comprises:
a plurality of antennas for receiving a signal from the MS and estimating the channels; and
a polarization phase and channel change measurer for measuring the channel variation and the electromagnetic wave of the estimated channels, and measuring a polarization phase of the measured electromagnetic wave.

12. The apparatus of claim 11, wherein the receiver further comprises:
a plurality of multipliers for multiplying the estimated channels by conjugates of the estimated channels; and
an adder for performing a Maximal Ratio Combining (MRC) by adding products received from the multipliers.

13. The apparatus of claim 6, wherein the transmitter comprises:
a controller for controlling the signal to be transmitted in at least one signal transmission scheme of beamforming using the estimated channels and polarization matching using an estimated polarization phase, according to the channel variation; and
a switch for switching the transmission signal according to the at least one signal transmission scheme.

14. The apparatus of claim 13, wherein the transmitter further comprises:
a polarization phase matcher for matching a polarization phase of an electromagnetic wave of the transmission signal to the polarization phase of the measured electromagnetic wave; and
a beamformer for performing a Maximal Ratio Combining (MRC) on the estimated channels.

15. The apparatus of claim 14, wherein the beamformer comprises:
an adder for performing beamforming on the transmission signal; and
a plurality of multipliers for multiplying a signal received from the adder by conjugates of the estimated channels.
